(19) United States
(12) Patent Application Publication
(10) Pub. No.: US 2024/0246184 A1
(43) Pub. Date: Jul. 25, 2024

(54) PART CHANGING APPARATUS AND PART CHANGING SYSTEM

(71) Applicant: FANUC CORPORATION, Yamanashi (JP)

(72) Inventors: Naoto OOWADA, Yamanashi (JP); Ryuuji SUZUKI, Yamanashi (JP)

(21) Appl. No.: 18/289,415

(22) PCT Filed: Jun. 16, 2021
(86) PCT No.: PCT/JP2021/022902

§ 371 Date: Nov. 3, 2023

(51) Int. Cl. B23Q 3/155; B23C 9/00

(52) U.S. Cl. CPC B23Q 3/1554; B23C 9/00; B23Q 2003/155404

(57) ABSTRACT

A cutting edge part changing apparatus for changing a cutting edge part fastened by a screw includes a cylindrical member, a cylindrical member holder that supports the cylindrical member movably along the direction of a central axis, and a driver bit that is inserted into the cylindrical member to be axially rotatable independently of the cylindrical member. A gap is provided as an air passage between the inner peripheral surface of the cylindrical member and the outer peripheral surface of the driver bit. Since the part to be changed can be sucked together with the screw, the efficiency of the operation of changing the part to be changed together with the screw is improved.

### TECHNICAL FIELD

The present invention relates to a part changing apparatus and a part changing system for changing a part to be changed that is fastened by a screw.

### BACKGROUND ART

As shown in FIG. 10, in a cutting edge replaceable cutting tool 101, a cutting edge part 103 with a cutting edge is fixed to a cylindrical holder 102 by a screw 104. Since the cutting edge part 103 needs to be firmly fixed to the holder 102 in order to receive the reaction force during machining, most of the part other than the portion that comes into contact with work material is embedded in the holder 102.

Since the cutting edge part 103 is smaller than the fingertips of the operator and has a sharp blade for machining, the operator needs to manually change the cutting edge part 103 while wearing protective gloves or the like. Fingertips are used to change small parts, and the difficulty of this work is not low when wearing gloves.

Since swarf, which is fine chips, is attached to the cutting edge part 103, the screw 104, and the holder 102 after machining, the operator needs to perform incidental work of removing the swarf by blowing air to the cutting edge part 103, the screw 104 for fixing the cutting edge, and the holder 102 prior to the work of removing the cutting edge part 103, so that the work efficiency is not high. The swarf removal work cannot be neglected because swarf remaining between the cutting edge part 103 and the holder 102 may deteriorate machining accuracy and cause machining defects to occur.

Further, as described above, most of the cutting edge part 103 other than the cutting edge is embedded in the holder 102, and the portion protruding from the holder 102 is very small, so that the cutting edge part 103 cannot be easily held with a robot hand or the like. It is also conceivable to attract the cutting edge part 103 by magnetic force in order to pick it up, but the cutting edge part 103 is magnetized, and magnetic swarf adheres thereto, making its removal even more difficult. Of course, when the cutting edge part 103 is made of a non-magnetic material, the cutting edge part 103 cannot be attracted by magnetic force.

### BRIEF DESCRIPTION OF THE DRAWINGS

FIG. 1 is a perspective view of a cutting edge part changing apparatus according to a first embodiment.

FIG. 2 is an A-A end view of FIG. 1

FIG. 3 is a perspective view showing a front end shape of a nozzle portion of a cylindrical member shown in FIG. 1.

FIG. 4 is an end view of the front end of a cylindrical member according to a modification of the first embodiment.

FIG. 5 is a diagram showing a cutting edge part changing system in which the cutting edge part changing apparatus shown in FIG. 1 is attached to the tip of an arm of a robot.

FIG. 6 is a diagram showing a process of changing a cutting edge part by the cutting edge part changing apparatus shown in FIG. 1.

FIG. 7 is a diagram showing a process of changing a cutting edge part following the process shown in FIG. 6.

FIG. 8 is an end view of a cutting edge part changing apparatus according to a second embodiment.

FIG. 9 is a supplemental diagram for explaining the operation of attaching a cutting edge part by the cutting edge part changing apparatus according to the second embodiment.

FIG. 10 is a perspective view showing a cutting edge replaceable cutting tool.

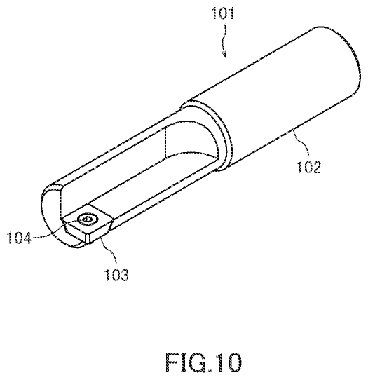

### DETAILED DESCRIPTION OF THE INVENTION

A part changing apparatus for changing a part to be changed that is fastened by a screw according to one aspect of the present disclosure includes a cylindrical member, a cylindrical member holder configured to support the cylindrical member movably along a central axis direction, and a driver bit configured to be inserted into the cylindrical member so as to be axially rotatable independently of the cylindrical member. A gap is provided as an air passage between an inner peripheral surface of the cylindrical member and an outer peripheral surface of the driver bit.

Embodiments of the present disclosure will be described below with reference to the drawings. In the following description, constituent elements having the same function and configuration are denoted by the same reference numeral, and repetitive descriptions will be given only where necessary. The present disclosure relates to a screw tightening apparatus for loosening and tightening a screw, and more particularly to a part changing apparatus capable of changing a part to be changed that is fastened to a pedestal or the like by a screw, by holding the part together with the screw by air suction. Here, a cutting edge part for cutting a workpiece will be described as an example of the part to be changed.

### First Embodiment

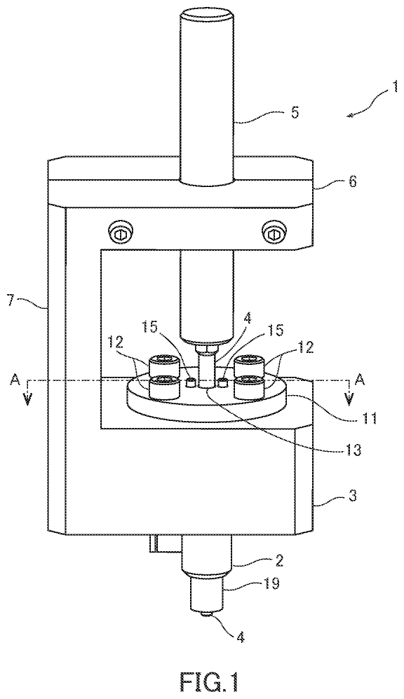

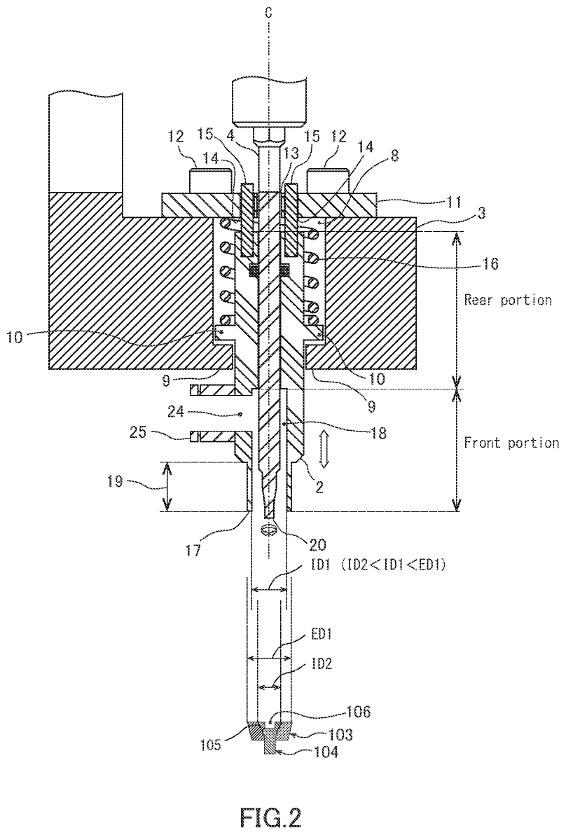

FIG. 1 is a perspective view of a cutting edge part changing apparatus according to a first embodiment, and FIG. 2 is an A-A end view of FIG. 1. For convenience of description, the lower side of the drawing will be referred to as the “front” or “lower” side, and the upper side of the drawing will be referred to as the “rear” or “upper” side. A cutting edge part changing apparatus 1 includes a cylindrical member 2 having a circular cylindrical hollow, a cylindrical member holder 3 that supports the cylindrical member 2 movably along the direction of a central axis C, a driver bit 4 that is inserted into the cylindrical member 2 so as to be axially rotatable independently of the cylindrical member 2, a nut runner 5 for driving the axial rotation of the driver bit 4, and a nut runner holder 6 that detachably fixes the nut runner 5 by a clamp mechanism or the like. The nut runner holder 6 is coupled to the cylindrical member holder 3. The nut runner holder 6 and the cylindrical member holder 3 are integrally formed as a U-shaped base block 7.

A circular-cylindrical through hole 8 is formed in the cylindrical member holder 3. The cylindrical member 2 is coaxially inserted into this through hole 8. An annular flange 9 protruding inward is provided at the lower peripheral edge of the through hole 8 of the cylindrical member holder 3. An annular flange portion 10 protruding outward from the middle of the cylindrical member 2 comes into contact with the flange 9 to restrict the downward movement of the cylindrical member 2. The through hole 8 of the cylindrical member holder 3 is covered with a disk-shaped holder cover 11 at its top. The holder cover 11 is fastened to the upper surface of the cylindrical member holder 3 at four positions by bolts 12. The upward movement of the cylindrical member 2 is restricted by the holder cover 11. The cylindrical member 2 is supported by the cylindrical member holder 3 movably between the flange 9 and the holder cover 11.

Typically, a cylinder mouth 17 of the cylindrical member 2 at the frontmost position (lowermost position) is located slightly behind a front end 20 of the driver bit 4, in other words, the front end 20 of the driver bit 4 protrudes slightly frontward from the cylinder mouth 17 of the cylindrical member 2 at the lowermost position. The operator can thereby fit the front end 20 of the driver bit 4 into a bit fitting groove 106 of a screw 104 while visually recognizing the front end 20 of the driver bit 4. The amount of protrusion of the front end 20 of the driver bit 4 with respect to the cylinder mouth 17 of the cylindrical member 2 at the lowermost position is arbitrarily adjusted with the depth (embedded amount) of the surface of a head 105 of the screw 104 from the surface of the cutting edge part 103 fixed to a holder 102 as the maximum value. As a result, with the front end 20 of the driver bit 4 fitted into the bit fitting groove 106 of the screw 104 of the holder 102, the cylinder mouth 17 of the cylindrical member 2 can be brought into contact with the surface of the cutting edge part 103 to ensure a state in which air suction is possible. This does not deny that the front end 20 of the driver bit 4 is located at the same position as and aligned with the cylinder mouth 17 of the cylindrical member 2 at the lowermost position, and that the front end 20 of the driver bit 4 is slightly set back from the cylinder mouth 17 of the cylindrical member 2 at the lowermost position.

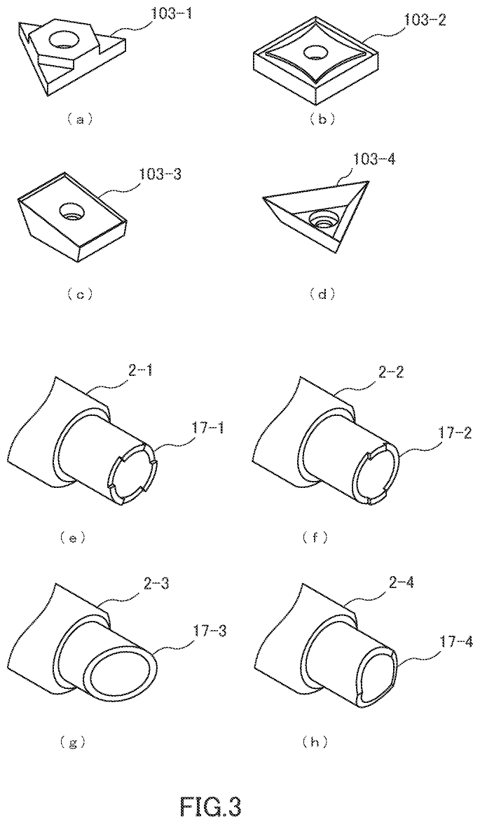

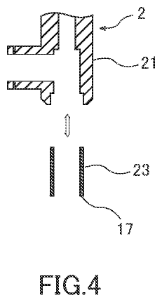

Here, by removing the holder cover 11 from the cylindrical member holder 3, the cylindrical member 2 can be pulled out upward from the through hole 8 of the cylindrical member holder 3, and the cylindrical member 2 can be inserted into the through hole 8 of the cylindrical member holder 3 from above, that is, the cylindrical member 2 can be easily attached and detached. As illustrated in FIG. 3(a) to FIG. 3(d), the cutting edge parts 103-1, 103-2, 103-3, and 103-4 with different cutting edge shapes are used as appropriate depending on the cutting method, specifications, and the like. In the cutting edge part changing apparatus 1, since air suction is performed with the cylinder mouth 17 of the cylindrical member 2 brought into contact with the surface of the cutting edge part 103, it is preferable to selectively use a cylindrical member 2 having a cylindrical shape conforming to the surface shape of the cutting edge part 103. It is possible to select, from various cylindrical members 2-1, 2-2, 2-3, and 2-4 with different shapes of cylinder mouths 17-1, 17-2, 17-3, and 17-4, the one conforming to one of the cutting edge parts 103-1, 103-2, 103-3, and 103-4 and easily change the current one to the selected one. As shown in FIG. 4, the cylindrical member 2 may be constituted by a cylindrical member main body 21 and a nozzle portion 23 that can be detachably attached to the cylindrical member main body 21 by screwing, fitting, or the like, and the nozzle portion 23 may be changed to a nozzle portion 23 having a cylindrical shape conforming to the surface shape of the cutting edge part 103 as appropriate.

Let us return to FIG. 1 and FIG. 2. An introduction hole 13 for introducing the driver bit 4 is formed in the center of the holder cover 11. A guide hole 14 extends through the holder cover 11 at two positions around the introduction hole 13. A guide pin 15 protruding from the rear end of the cylindrical member 2 is slidably inserted into the guide hole 14. This suppresses the tilting of the cylindrical member 2, and ensures movement parallel to the central axis C of the cylindrical member 2.

A compression coil spring 16 is fitted around the cylindrical member 2. The compression coil spring 16 is placed between the holder cover 11 and the flange portion 10. The cylindrical member 2 is urged frontward by the compression coil spring 16. Note that the compression coil spring 16 can be replaced with other urging members such as a tension spring and a plate spring.

The front end of the cylindrical member 2 is thin and forms a nozzle portion 19. The inner diameter of the cylindrical member 2 is not uniform from the cylinder mouth 17 at the front end to the rear end, but changes in the middle of the center axis C. The inner diameter of a portion (front portion) from the front end of the cylindrical member 2 to a position a predetermined distance behind is large, and the inner diameter of a portion (rear portion) behind the front portion is smaller than the inner diameter of the front portion. The inner diameter of the rear portion is slightly larger than the outer diameter of the driver bit 4 to such an extent as to tolerate the axial rotation of the driver bit 4 and suppress its runout, and is almost equivalent thereto, whereas the inner diameter ID1 of the front portion is sufficiently larger than the outer diameter of the driver bit 4 so that the inner peripheral surface of the cylindrical member 2 is separated from the outer peripheral surface of the driver bit 4 by a predetermined distance of, for example, several millimeters, and a gap as an air passage 18 is ensured between the inner peripheral surface of the cylindrical member 2 and the outer peripheral surface of the driver bit 4.

Further, the inner diameter ID1 of the front portion of the cylindrical member 2 is smaller than the outer diameter (or outer dimension) ED1 of the surface of the cutting edge part 103 as the part to be changed and larger than the inner diameter (or inner dimension) ID2 of the surface of the cutting edge part 103. As a result, the cylinder mouth 17 comes into contact with the surface of the cutting edge part 103, and the surface portion of the cutting edge part 103 inside the surface portion that comes into contact with the cylindrical opening 17 is exposed to the air passage 18, so that when the air passage 18 is sucked to a negative pressure, air is not sucked into the cylindrical member 2, and the cylindrical member 2 can be sucked.

Note that the transverse sectional shape of the rear portion of the cylindrical member 2 is a circle so as not to hinder the axial rotation of the driver bit 4, whereas the transverse sectional shape of the front portion of the cylindrical member 2, which constitutes the air passage 18, is typically a circle, but may be a polygon such as a triangle or a square.

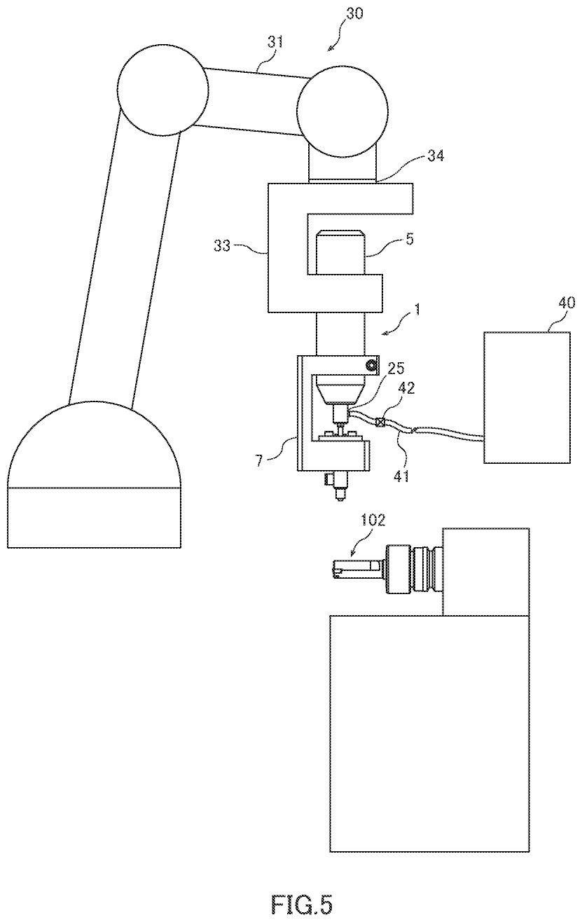

A circular opening 24 is formed in the side wall of the front portion of the cylindrical member 2. The opening 24 communicates with the air passage 18, and a tubular air connection portion 25 is attached to the opening 24 so as to face outward. As shown in FIG. 5, an air hose 41 is connected to the air connection portion 25, and an air pump device (vacuum pump device) 40 is connected to the opposite side of the air hose 41. Air is drawn from the air passage 18 by the air pump device 40. As a result, a negative pressure is generated in the air passage 18, and the cutting edge part 103 can be sucked together with the screw 104. An air switch 42 is interposed in the air hose 41. Air is supplied to the air passage 18 by switching of the air switch 42. As a result, air is supplied to the air passage 18, and air is blown out from the cylinder mouth 17. The air blow can remove swarf adhering to the cutting edge part 103 and the screw 104.

The operator can change the cutting edge part 103 while holding the cutting edge part changing apparatus 1. As shown in FIG. 5, the cutting edge part changing apparatus 1 may be attached to a tool changer 34 at the tip of an articulated arm 31 of a robot 30 to automate the changing of the cutting edge part 103. In the latter case, the cutting edge part changing apparatus 1 constitutes a cutting edge part changing system, together with the robot 30 and a control device (not shown) that controls the cutting edge part changing apparatus 1 and the robot 30 to proceed with the cutting edge part changing operation. Hereinafter, the changing operation will be described using the cutting edge part changing system as an example.

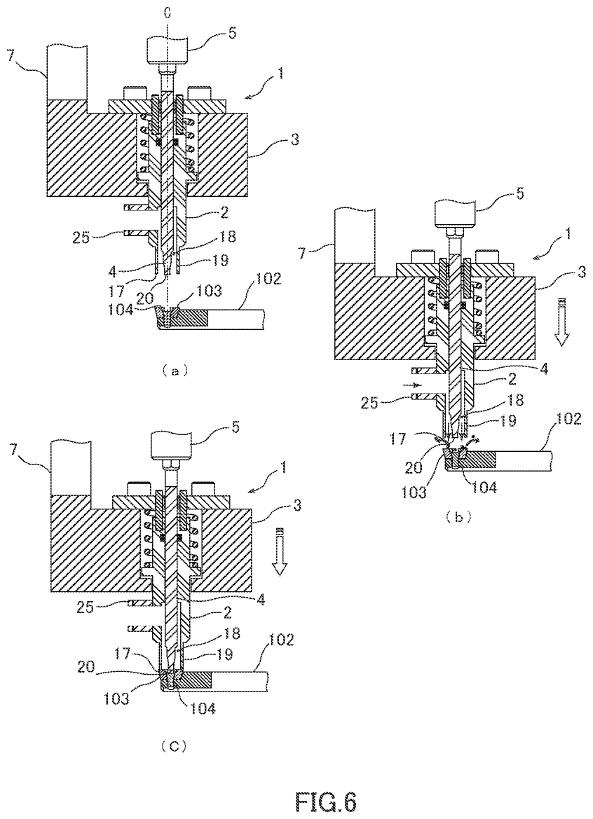

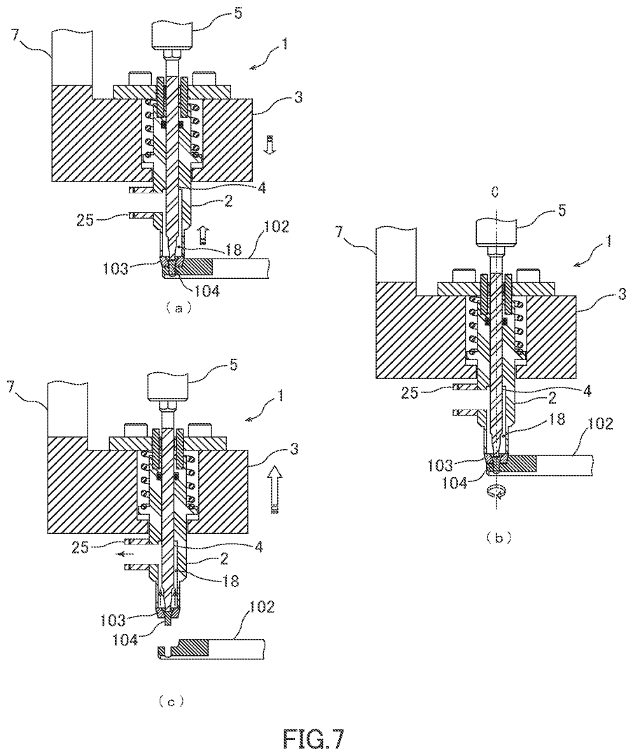

FIG. 6 and FIG. 7 show a process of removing the cutting edge part 103 from the holder 102 by the cutting edge part changing apparatus 1. First, as shown in FIG. 6(a), the cutting edge part changing apparatus 1 is moved by an operation of the articulated arm 31 of the robot 30, and the cylinder mouth 17 of the cylindrical member 2 and the front end 20 of the driver bit 4 are disposed above the cutting edge part 103 to be changed and the screw 104, respectively. Next, as shown in FIG. 6(b), the cutting edge part changing apparatus 1 is lowered, and the cylinder mouth 17 approaches a position a predetermined distance away from the cutting edge part 103. Then, the air pump device 40 is driven, air is supplied to the air passage 18, and air is blown out from the cylinder mouth 17. As a result, the swarf adhering to the cutting edge part 103 and the screw 104 is blown off and removed. The removal of swarf suppresses fitting failure of the front end 20 of the driver bit 4 to the bit fitting groove 106 of the screw 104 in the subsequent process, and prevents swarf from being trapped when reassembling a new cutting edge part 103, thereby suppressing lowering of machining accuracy.

After the removal of swarf is completed, the cutting edge part changing apparatus 1 is lowered again. When the cutting edge part changing apparatus 1 is lowered again, as shown in FIG. 6(c), the cylinder mouth 17 is first brought into contact with the surface of the cutting edge part 103 since the screw 104 is embedded in the cutting edge part 103. Then, as shown in FIG. 7(a), the cutting edge part changing apparatus 1 is further lowered until the front end 20 of the driver bit 4 is fitted into the bit fitting groove 106 of the screw 104. During this time, the cylinder mouth 17 is maintained in a contact state of being pressed against the surface of the cutting edge part 103 as the cutting edge part changing apparatus 1 is lowered since the cylindrical member 2 is movable and is urged frontward by the compression coil spring 16.

Next, as shown in FIG. 7(b), the driver bit 4 is axially rotated by the driving of the nut runner 5. As a result, the screw 104 is loosened and removed from the screw hole of the holder 102. The air pump device 40 is then driven as the air switch 42 is switched, generating a negative pressure in the air passage 18, and the cutting edge part 103 is sucked to the cylinder mouth 17. Since the screw 104 is held by the front end 20 of the driver bit 4, it is sucked together with the cutting edge part 103 while being inserted into the screw hole of the cutting edge part 103. Also, outside air is sucked in through the screw hole of the cutting edge part 103, releasing the vacuum state of the air passage 18 and preventing the cutting edge part 103 from falling.

As shown in FIG. 7(c), the cutting edge part 103 sucked to the cylinder mouth 17 is separated from the holder 102 together with the screw 104 as the cutting edge part changing apparatus 1 is lifted by an operation of the articulated arm 31 of the robot 30. The sucked cutting edge part 103 and the screw 104 are transferred directly to a cutting edge part tray (not shown).

Note that a new cutting edge part 103 can be attached to the holder 102 in the reverse procedure of the removal process described above.

As described above, according to the present embodiment, regardless of the materials of the cutting edge art 103 as the part to be changed and the screw 104 that fixes the cutting edge part 103, removal of swarf by air blowing, loosening of the screw 104, and pick-up of the cutting edge part 103 and the screw 104 can be achieved as a series of operations while holding the cutting edge part changing apparatus 1 without the need to hold the cutting edge part 103 and without the need to hold an air blowing device instead of the cutting edge part changing apparatus 1, so that the cutting edge part 103 can be efficiently changed, and moreover, the operator is freed from the work of attaching and removing small parts and the risk of cutting fingers with the blade. In addition, by configuring the cutting edge part changing system by attaching the cutting edge part changing apparatus 1 to the tip of the arm of the robot 30, it is possible to automate the cutting edge part changing, in which case, it is not necessary to hold both the screw 104 and the cutting edge part 103 separately with two arms, and the equipment cost can be reduced.

### Second Embodiment

In the first embodiment described above, the screw 104 is not directly sucked, and therefore, when the cutting edge part 103 is attached to the holder 102, the screw 104 needs to be inserted into the screw hole of the cutting edge part 103 as an advance preparation. In addition, the sward in the bit fitting groove 106 of the screw 104 is not removed by blowing air directly on the swarf, but indirectly by entrainment or the like of air blown on the surface of the cutting edge part 103. The second embodiment achieves direct suction of the screw 104 and removal of the swarf in the bit fitting groove 106 of the screw 104 by direct air blowing.

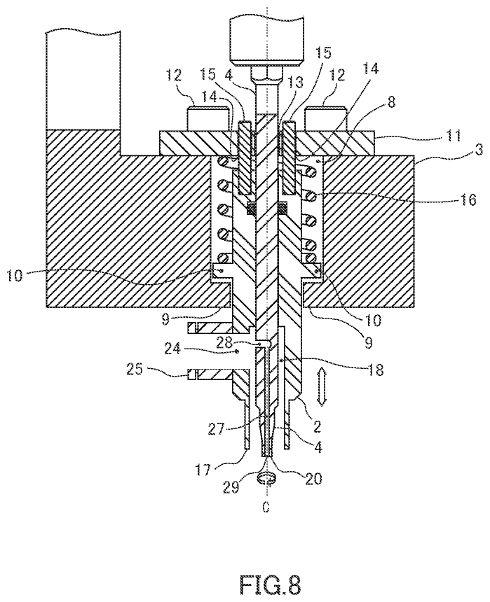

As shown in FIG. 8, the front end 20 of the driver bit 4 installed in the cutting edge part changing apparatus 1 according to the present embodiment is open, and an axial center hole 27 is drilled rearward from the opening 29 of the front end 20 to a middle point of the driver bit 4. The driver bit 4 is provided with a lateral hole 28 drilled at its rear end or middle position, and the axial center hole 27 communicates with the air passage 18 through the lateral hole 28.

When air is supplied to the air passage 18, air is blown out from the cylinder mouth 17 via the air passage 18 between the cylindrical member 2 and the driver bit 4, and air is also blown out from the front end opening 29 of the driver bit 4 via the lateral hole 28 and the axial center hole 27 (air blow function). This allows air to be blown directly to the swarf in the bit fitting groove 106 of the screw 104 so that the swarf in the bit fitting groove 106 of the screw 104 is effectively removed, thereby substantially eliminating the fitting failure of the front end 20 of the driver bit 4 to the bit fitting groove 106 of the screw 104.

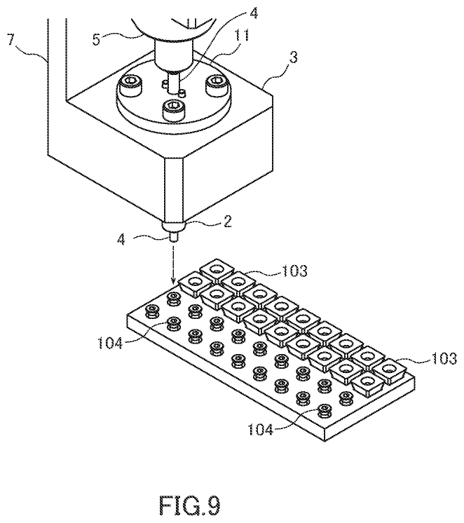

When the air in the air passage 18 is sucked, a negative pressure is generated in the axial center hole 27 of the driver bit 4 as well as in the air passage 18. This allows the screw 104 to be sucked by itself, and for example, as shown in FIG. 9, the screw 104 can be picked up by the cutting edge part changing apparatus and inserted into the screw hole of the cutting edge part 103. The cutting edge part 103 can be sucked together with the screw 104 and transferred to and attached to the holder 102.

The other embodiment can perform the same advantage as the first embodiment.

The present invention is not limited to the above-described embodiments, and can be modified in various ways in practice, without departing from the gist of the invention. In addition, the embodiments may be combined as appropriate, in which case a combined advantage can be attained. Furthermore, the above-described embodiments include various inventions, and various inventions can be extracted by combining structural elements selected from a plurality of structural elements disclosed herein. For example, even if some structural elements of all the structural elements disclosed in the embodiments are deleted, the embodiment from which those structural elements are deleted can be extracted as an invention as long as the problems can be solved, and the advantages can be attained.

1. A part changing apparatus for changing a part to be changed that is fastened by a screw, comprising:
a cylindrical member;
a cylindrical member holder configured to support the cylindrical member movably along a central axis direction; and
a driver bit configured to be inserted into the cylindrical member so as to be axially rotatable independently of the cylindrical member, wherein
a gap is provided as an air passage between an inner peripheral surface of the cylindrical member and an outer peripheral surface of the driver bit.

2. The part changing apparatus according to claim 1, further comprising an urging member configured to urge the cylindrical member in a front end direction.

3. The part changing apparatus according to claim 1, wherein the air passage is provided in a range from a cylinder mouth of the cylindrical member to a position a predetermined distance behind the cylinder mouth.

4. The part changing apparatus according to claim 3, wherein an O-ring is interposed between the cylindrical member and the driver bit at a position behind the air passage.

5. The part changing apparatus according to claim 1, further comprising: a nut runner holder coupled to the cylindrical member holder; and a nut runner detachably held by the nut runner holder for axially rotating the driver bit.

6. The part changing apparatus according to claim 1, wherein the driver bit is provided with an axial center hole communicating with the air passage.

7. The part changing apparatus according to claim 1, wherein an opening communicating with the air passage is provided in a side wall of the cylindrical member, and an air pump device is connected to the opening via an air hose.

8. The part changing apparatus according to claim 7, further comprising: a switch interposed between the opening and the air pump device for switching between air suction and supply.

9. The part changing apparatus according to claim 1, wherein the cylindrical member is detachably attachable to the cylindrical member holder.

10. The part changing apparatus according to claim 1, wherein the cylindrical member includes a cylindrical member main body and a nozzle portion detachably attachable to the cylindrical member main body.

11. A part changing system comprising: the part changing apparatus according to claim 1; and a robot equipped with the part changing apparatus at a tip of an arm of the robot.
